(19) United States
(12) Patent Application Publication
(10) Pub. No.: US 2025/0354272 A1
(43) Pub. Date: Nov. 20, 2025

(54) ELECTROCHEMICAL SYSTEM

(71) Applicants: Hyundai Motor Company, Seoul (KR); Kia Corporation, Seoul (KR)

(72) Inventors: Seok Hwon Lee, Hwaseong (KR); Ji Soo Kim, Hwaseong (KR); Kwi Seong Jeong, Hwaseong (KR)

(21) Appl. No.: 18/897,068

(22) Filed: Sep. 26, 2024

(30) Foreign Application Priority Data
May 14, 2024 (KR) 10-2024-0063476

(51) Int. Cl. C25B 1/04; C25B 15/033; C25B 15/08

(52) U.S. Cl. CPC C25B 1/04; C25B 15/033; C25B 15/08

(57) ABSTRACT

Provided is an electrochemical system comprising a water electrolysis stack with an anode and a cathode. The system includes a reaction fluid supply line that supplies a reaction fluid to the anode, a first gas-liquid separator located in the reaction fluid supply line to separate the reaction fluid into gaseous and liquid components, and a first filter part positioned upstream of the first gas-liquid separator to filter the reaction fluid. The system further includes a first circulation line that circulates the liquid reaction fluid from the anode back to the first gas-liquid separator. Additionally, a second gas-liquid separator in a discharged fluid discharge line is connected to the cathode, with a second circulation line configured to maintain the ionic purity of the discharged fluid. The system also includes a mechanism to monitor ionic conductivity and selectively control the operation of the water electrolysis stack based on detected ionic levels.

### CROSS-REFERENCE TO RELATED APPLICATION

This application claims under 35 U.S.C. § 119(a) the benefit of Korean Patent Application No. 10-2024-0063476 filed in the Korean Intellectual Property Office on May 14, 2024, the entire contents of which are incorporated herein by reference.

### BACKGROUND

### Technical Field

The present disclosure relates to an electrochemical system, and more particularly, to a water electrolysis system designed to enhance the performance, durability, and stability of a water electrolysis stack by incorporating mechanisms for monitoring and controlling the ionic purity of the reaction and discharged fluids. The system includes advanced filtration and sensor technologies that allow for real-time adjustments and maintenance, ensuring optimal operation and prolonged lifespan of the water electrolysis stack.

### Background

There is a consistently increasing need for research and development on alternative energy to cope with global warming and depletion of fossil fuel. Hydrogen energy is attracting attention as a practical solution for solving environmental and energy issues.

In particular, because hydrogen has high energy density and properties suitable for application on a grid-scale, hydrogen is in the limelight as a future energy carrier.

A water electrolysis stack, which is one of electrochemical apparatuses, refers to a device that produces hydrogen and oxygen by electrochemically decomposing water. The water electrolysis stack may be configured by stacking several tens or several hundreds of water electrolysis cells (unit cells) in series.

Meanwhile, when a reaction fluid (reactant) (e.g., water) to be supplied to the electrochemical device (e.g., the water electrolysis stack) contains ions and foreign substances (impurities), the performance, durability, and reliability of the electrochemical device are degraded. Therefore, it is necessary to remove ions and foreign substances contained in the reaction fluid as much as possible.

### SUMMARY

The present disclosure has been made in an effort to provide a filter device for an electrochemical apparatus capable of ensuring the performance of a water electrolysis stack and improving the durability and stability of the water electrolysis stack.

In particular, the present disclosure has been made in an effort to allow a low-quality reaction fluid (e.g., a reaction fluid having high ionic conductivity) to flow along a first bypass line and be reprocessed (e.g., deionized) without being supplied to the water electrolysis stack.

Among other things, the present disclosure has been made in an effort to extend the lifespan of the water electrolysis stack and minimize the deterioration in durability and stability of the water electrolysis stack caused when the low-quality reaction fluid is supplied to the water electrolysis stack.

The present disclosure has also been made in an effort to improve the quality and recyclability of the reaction fluid and reduce the amount of use of the reaction fluid.

In particular, the present disclosure has been made in an effort to reuse a discharged fluid, which is discharged from a cathode, as the reaction fluid.

The present disclosure has also been made in an effort to flush (clean) the cathode by using the discharged fluid without a separate flushing device.

The objects to be achieved by the embodiments are not limited to the above-mentioned objects, but also include objects or effects that may be understood from the solutions or embodiments described below.

In order to achieve the above-mentioned objects, an example embodiment of the present disclosure provides an electrochemical system including: a water electrolysis stack including an anode and a cathode; a reaction fluid supply line configured to supply a reaction fluid to the anode; a first gas-liquid separator provided in the reaction fluid supply line and configured to separate the reaction fluid into a gaseous reaction fluid and a liquid reaction fluid; a first filter part provided in the reaction fluid supply line, positioned at an upstream side of the first gas-liquid separator, and configured to filter the reaction fluid; a first circulation line configured to connect the first gas-liquid separator and the anode and circulate the liquid reaction fluid, which has passed through the anode, to the first gas-liquid separator; and a first bypass line having one end provided between the first gas-liquid separator and the water electrolysis stack and connected to the reaction fluid supply line, and the other end provided at an upstream side of the first filter part and connected to the reaction fluid supply line.

In some embodiments, an electrochemical system comprises a water electrolysis stack with an anode and a cathode, a reaction fluid supply line configured to supply a reaction fluid to the anode, a first gas-liquid separator located in the reaction fluid supply line and configured to separate the reaction fluid into a gaseous reaction fluid and a liquid reaction fluid, a first filter part located upstream of the first gas-liquid separator within the reaction fluid supply line and configured to filter the reaction fluid, and a first circulation line connecting the first gas-liquid separator and the anode to circulate the liquid reaction fluid, which has passed through the anode, back to the first gas-liquid separator. Additionally, the system includes a first bypass line, with one end located between the first gas-liquid separator and the water electrolysis stack, and the other end located upstream of the first filter part, both ends being connected to the reaction fluid supply line.

The system may also include a first ion sensor located in the reaction fluid supply line upstream of the first gas-liquid separator, configured to sense the ionic conductivity of the reaction fluid, wherein the operation of the water electrolysis stack is selectively controlled based on the detection by the first ion sensor. In certain preferred aspects, a first valve such as a three-way valve may be located in the reaction fluid supply line and connected to one end of the first bypass line, with a second ion sensor located in at least one of the reaction fluid supply line and the first circulation line, configured to sense the ionic conductivity of the liquid reaction fluid, wherein the first three-way valve selectively switches the flow of the liquid reaction fluid from the downstream side of the first gas-liquid separator to the upstream side of the first gas-liquid separator based on the detection by the second ion sensor. In certain preferred aspects, the first filter part may be replaced when the ionic conductivity of the liquid reaction fluid detected by the second ion sensor is equal to or higher than a preset reference ionic conductivity after a preset reference time elapses following the switch of the liquid reaction fluid flow from the downstream side to the upstream side of the first gas-liquid separator.

In some embodiments, the system further includes a discharged fluid discharge line connected to the cathode and configured to discharge a discharged fluid from the cathode, a second gas-liquid separator located in the discharged fluid discharge line and configured to separate the discharged fluid into gaseous and liquid components, and a second circulation line connecting the second gas-liquid separator to the reaction fluid supply line to circulate the liquid discharged fluid back to the reaction fluid supply line. Additionally, in certain preferred aspects, the system may comprise a reaction fluid storage part located in the reaction fluid supply line upstream of the first filter part and configured to store the reaction fluid, and a pre-processing filter part located upstream of the reaction fluid storage part within the reaction fluid supply line, configured to filter the reaction fluid, with the second circulation line connected to the reaction fluid storage part. In certain preferred aspects, the system may also include a second filter part located in the second circulation line and configured to filter the liquid discharged fluid, along with a second bypass line, one end of which is located downstream of the second filter part and connected to the second circulation line, and the other end connected to the cathode.

Furthermore, in certain preferred aspects, a second valve such as a three-way valve may be located in the second circulation line and connected to one end of the second bypass line, and a third ion sensor may be located in at least one of the discharged fluid discharge line and the second circulation line, configured to sense the ionic conductivity of the liquid discharged fluid, wherein the second three-way valve selectively switches the flow of the liquid discharged fluid from the downstream side of the second filter part to the cathode based on the detection by the third ion sensor. In certain preferred aspects, the second filter part may be replaced when the ionic conductivity of the liquid discharged fluid detected by the third ion sensor is equal to or higher than the preset reference ionic conductivity after a preset reference time elapses following the switch of the liquid discharged fluid flow from the downstream side of the second filter part to the cathode.

In some embodiments, the system includes a reaction fluid storage part located upstream of the first filter part, configured to store the reaction fluid before it is supplied to the first filter part. In certain preferred aspects, the system may also include a system configured to selectively stop the operation of the water electrolysis stack based on the ionic conductivity detected by the first and second ion sensors. Additionally, In certain preferred aspects, the system may be configured to trigger an alert or notification when the ionic conductivity detected by the first or second ion sensor exceeds a predetermined threshold.

According to a further exemplary embodiment of the present disclosure, the electrochemical system may include: a first ion sensor provided in the reaction fluid supply line, disposed at the upstream side of the first gas-liquid separator, and configured to sense ionic conductivity of the reaction fluid, in which an operation of the water electrolysis stack is selectively stopped on the basis of a result detected by the first ion sensor.

According to the exemplary embodiment of the present disclosure, the electrochemical system may include a first three-way valve provided in the reaction fluid supply line and connected to one end of the first bypass line.

According to the exemplary embodiment of the present disclosure, the electrochemical system may include: a second ion sensor provided in at least any one of the reaction fluid supply line and the first circulation line and configured to sense ionic conductivity of the liquid reaction fluid, in which the first three-way valve selectively switches a flow of the liquid reaction fluid from a downstream side of the first gas-liquid separator to the upstream side of the first gas-liquid separator on the basis of a result detected by the second ion sensor.

According to the exemplary embodiment of the present disclosure, the first filter part may be replaced when the ionic conductivity of the liquid reaction fluid detected by the second ion sensor is equal to or higher than preset reference ionic conductivity when a preset reference time elapses after the flow of the liquid reaction fluid is switched from the downstream side of the first gas-liquid separator to the upstream side of the first gas-liquid separator.

According to the exemplary embodiment of the present disclosure, the electrochemical system may include: a discharged fluid discharge line connected to the cathode and configured to discharge a discharged fluid from the cathode; a second gas-liquid separator provided in the discharged fluid discharge line and configured to separate the discharged fluid into a gaseous discharged fluid and a liquid discharged fluid; and a second circulation line configured to connect the second gas-liquid separator and the reaction fluid supply line and circulate the liquid discharged fluid to the reaction fluid supply line.

According to the exemplary embodiment of the present disclosure, the electrochemical system may include: a reaction fluid storage part provided in the reaction fluid supply line, disposed at the upstream side of the first filter part, and configured to store the reaction fluid; and a pre-processing filter part provided in the reaction fluid supply line, disposed at an upstream side of the reaction fluid storage part, and configured to filter the reaction fluid, in which the second circulation line is connected to the reaction fluid storage part.

According to the exemplary embodiment of the present disclosure, the electrochemical system may include: a second filter part provided in the second circulation line and configured to filter the liquid discharged fluid.

According to the exemplary embodiment of the present disclosure, the electrochemical system may include: a second bypass line having one end provided at a downstream side of the second filter part and connected to the second circulation line, and the other end connected to the cathode.

According to the exemplary embodiment of the present disclosure, the electrochemical system may include: a second three-way valve provided in the second circulation line and connected to one end of the second bypass line.

According to the exemplary embodiment of the present disclosure, the electrochemical system may include: a third ion sensor provided in at least any one of the discharged fluid discharge line and the second circulation line and configured to sense ionic conductivity of the liquid discharged fluid, in which the second three-way valve selectively switches a flow of the liquid discharged fluid from the downstream side of the second filter part to the cathode on the basis of a result detected by the third ion sensor.

According to the exemplary embodiment of the present disclosure, the second filter part may be replaced when the ionic conductivity of the liquid discharged fluid detected by the third ion sensor is equal to or higher than preset reference ionic conductivity when a preset reference time elapses after the flow of the liquid discharged fluid is switched from the downstream side of the second filter part to the cathode.

According to the exemplary embodiment of the present disclosure, the electrochemical system may include: a discharged fluid storage part provided in the second circulation line, disposed at a downstream side of the second filter part, and configured to store the liquid discharged fluid.

### BRIEF DESCRIPTION OF THE DRAWINGS

FIG. 1 is a view for explaining an electrochemical system according to an embodiment of the present disclosure.

FIG. 2 is a view for explaining movement paths for a reaction fluid and a discharged fluid in the electrochemical system according to the embodiment of the present disclosure.

FIG. 3 is a view for explaining a movement path for the reaction fluid along a first bypass line in the electrochemical system according to the embodiment of the present disclosure.

FIG. 4 is a view for explaining a movement path for the discharged fluid along a second bypass line in the electrochemical system according to the embodiment of the present disclosure.

### DETAILED DESCRIPTION

Hereinafter, example embodiments of the present disclosure will be described in detail with reference to the accompanying drawings.

However, the technical spirit of the present disclosure is not limited to some embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected’, ‘coupled’, or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

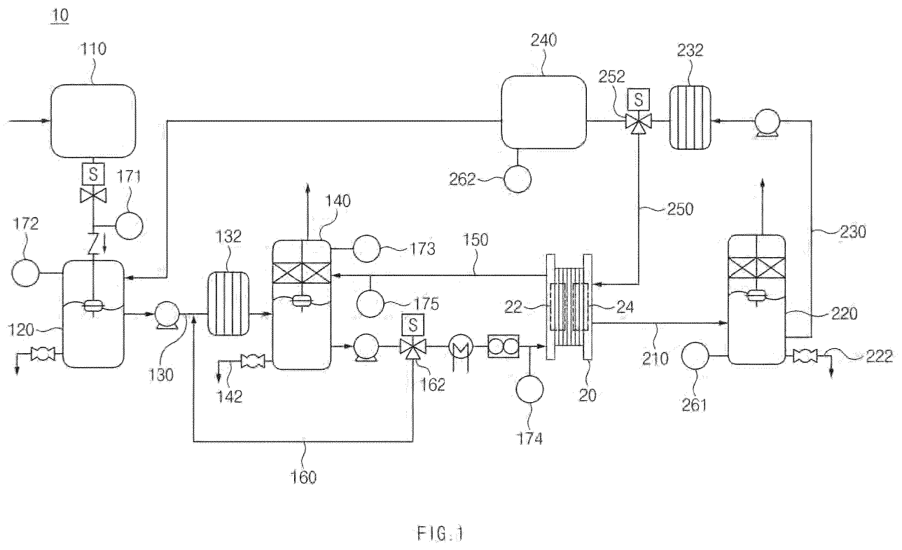

With reference to FIGS. 1 to 4, an electrochemical system 10 according to an embodiment of the present disclosure includes a water electrolysis stack 20 including an anode 22 and a cathode 24, a reaction fluid supply line 130 through which a reaction fluid is supplied to the anode 22, a first gas-liquid separator 140 provided in the reaction fluid supply line 130 and configured to separate the reaction fluid into a gaseous reaction fluid and a liquid reaction fluid, a first filter part 132 provided in the reaction fluid supply line 130, positioned at an upstream side of the first gas-liquid separator 140, and configured to filter the reaction fluid, a first circulation line 150 configured to connect the first gas-liquid separator 140 and the anode 22 and configured to circulate the liquid reaction fluid, which has passed through the anode 22, to the first gas-liquid separator 140, and a first bypass line 160 having one end provided between the first gas-liquid separator 140 and the water electrolysis stack 20 and connected to the reaction fluid supply line 130, and the other end provided at an upstream side of the first filter part 132 and connected to the reaction fluid supply line 130.

For reference, the electrochemical system 10 according to the embodiment of the present disclosure may be used to generate electrochemical reactions between various reaction fluids in accordance with required conditions and design specifications. The present disclosure is not restricted or limited by the type and property of the reaction fluid used for the electrochemical system 10.

For example, the electrochemical system 10 according to the embodiment of the present disclosure may be used to produce hydrogen and oxygen by decomposing water (reaction fluid) through an electrochemical reaction.

The water electrolysis stack 20 includes the anode 22 and the cathode 24 and is provided in the first circulation line 150 to produce hydrogen and oxygen by decomposing water (reaction fluid) through an electrochemical reaction.

The water electrolysis stack 20 may have various structures capable of producing hydrogen and oxygen by decomposing the reaction fluid through the electrochemical reaction. The present disclosure is not restricted or limited by the type and structure of the water electrolysis stack 20.

For example, the water electrolysis stack 20 may be made by stacking a plurality of unit cells (not illustrated) in a preset reference stacking direction.

More specifically, the unit cell may include a reaction layer (not illustrated), and separators (not illustrated) respectively stacked on two opposite surfaces of the reaction layer. The water electrolysis stack 20 may be configured by stacking the plurality of unit cells in the reference stacking direction and then fastening endplates (not illustrated) to two opposite ends of the stack of the plurality of unit cells.

The reaction layer may have various structures capable of generating the electrochemical reaction of the reaction fluid (e.g., water). The present disclosure is not restricted or limited by the type and structure of the reaction layer.

For example, the reaction layer may include a membrane electrode assembly (MEA) (not illustrated), a first porous transport layer (not illustrated) in close contact with one surface of the membrane electrode assembly, and a second porous transport layer (not illustrated) in close contact with the other surface of the membrane electrode assembly.

The membrane electrode assembly may be variously changed in structure and material in accordance with required conditions and design specifications. The present disclosure is not restricted or limited by the structure and material of the membrane electrode assembly.

For example, the membrane electrode assembly may be configured by attaching catalyst electrode layers (e.g., an anode electrode layer and a cathode electrode layer), in which electrochemical reactions are generated, to two opposite surfaces of an electrolyte membrane.

The first and second porous transport layers may uniformly distribute the reaction fluid and each have a porous structure having pores with predetermined sizes.

For reference, water supplied to the anode 22 (anode electrode layer), which is an oxidation electrode for the water electrolysis, is separated into hydrogen ions (protons), electrons, and oxygen. The hydrogen ions move to the cathode 24 (cathode electrode layer), which is a reduction electrode, through the electrolyte membrane, and the electrons move to the cathode 24 through an external circuit. In addition, the oxygen may be discharged through an outlet of the anode 22, and the hydrogen ions and the electrons may be converted into hydrogen in the cathode 24.

The reaction fluid supply line 130 is configured to supply the reaction fluid (e.g., water) to the water electrolysis stack 20.

The reaction fluid supply line 130 may have various structures capable of supplying the reaction fluid. The present disclosure is not restricted or limited by the structure and shape of the reaction fluid supply line 130.

For example, the reaction fluid supply line 130 may be defined in an approximately straight shape. According to another embodiment of the present disclosure, the reaction fluid supply line may be defined in a curved shape or other shapes.

In addition, the reaction fluid supply line 130 may be equipped with various types of accessory devices, such as a pump (not illustrated) configured to forcibly move the reaction fluid along the reaction fluid supply line 130, and a valve (not illustrated) configured to selectively open or close the reaction fluid supply line 130. The present disclosure is not restricted or limited by the types of accessory devices and the number of accessory devices.

According to the example embodiment of the present disclosure, the electrochemical system 10 may include a reaction fluid storage part 120 provided in the reaction fluid supply line 130, disposed at an upstream side of the first filter part 132, and configured to store the reaction fluid, and a pre-processing filter part 110 provided in the reaction fluid supply line 130, disposed at an upstream side of the reaction fluid storage part 120, and configured to filter the reaction fluid. A second circulation line 230 may be connected to the reaction fluid storage part 120.

The reaction fluid storage part 120 may have various structures capable of storing the reaction fluid. The present disclosure is not restricted or limited by the structure and shape of the reaction fluid storage part 120.

For example, the reaction fluid storage part 120 may be provided in the form of a hollow tank. The reaction fluid having passed through the pre-processing filter part 110 may be temporarily stored in the reaction fluid storage part 120 and separated into the gaseous reaction fluid and the liquid reaction fluid before being supplied to the first gas-liquid separator 140.

In addition, a drain port (not illustrated) may be provided at an approximately lower end of the reaction fluid storage part 120 and configured to selectively discharge the reaction fluid in the reaction fluid storage part 120 to the outside.

The pre-processing filter part 110 may have various structures capable of filtering out ions and foreign substances (impurities) contained in the reaction fluid. The present disclosure is not restricted or limited by the type and structure of the pre-processing filter part 110.

The first gas-liquid separator 140 is connected to the reaction fluid supply line 130 and configured to separate the reaction fluid into the gaseous reaction fluid (e.g., oxygen) and the liquid reaction fluid (e.g., water).

Various separation devices capable of separating the reaction fluid into the gaseous reaction fluid and the liquid reaction fluid may be used as the first gas-liquid separator 140. The present disclosure is not restricted or limited by the type and structure of the first gas-liquid separator 140.

For example, the first gas-liquid separator 140 may be provided in the form of a hollow tank. For example, the reaction fluid supply line 130 may be connected to an approximately central portion of the first gas-liquid separator 140. A first discharge line 142 may be provided at an approximately lower end of the first gas-liquid separator 140 and configured to selectively discharge the liquid reaction fluid in the first gas-liquid separator 140 to the outside. In addition, a level sensor (not illustrated) may be provided in the first gas-liquid separator 140 and configured to detect a level of the liquid reaction fluid.

The first filter part 132 is provided in the reaction fluid supply line 130, positioned at an upstream side the first gas-liquid separator 140, and configured to filter the reaction fluid to be supplied to the first gas-liquid separator 140.

Various ion filters capable of filtering out ions and foreign substances (impurities) contained in the reaction fluid may be used as the first filter part 132. The present disclosure is not restricted or limited by the type and properties of the ion filter. For example, a prefilter, a carbon filter, a RO membrane filter, an ion exchange resin, a UV Lamp, or the like may be used as the first filter part 132.

For reference, in the embodiment of the present disclosure, an example is described in which the first filter part 132 includes a single ion filter. However, according to another embodiment of the present disclosure, the first filter part may be configured by connecting a plurality of ion filters in parallel or in series.

The first circulation line 150 may be configured to connect the first gas-liquid separator 140 and the anode 22. The liquid reaction fluid having passed through the anode 22 may circulate to the first gas-liquid separator 140 along the first circulation line 150.

More specifically, the liquid reaction fluid separated by the first gas-liquid separator 140 may be supplied to the anode 22 of the water electrolysis stack 20. The liquid reaction fluid having passed through the anode 22 may be supplied back to the first gas-liquid separator 140 along the first circulation line 150.

The first circulation line 150 may have various structures capable of connecting the outlet of the anode 22 and the first gas-liquid separator 140. The present disclosure is not restricted or limited by the structure and shape of the first circulation line 150.

Hereinafter, an example will be described in which the first circulation line 150 is connected to a lateral side (based on FIG. 1) of the first gas-liquid separator 140. According to another embodiment of the present disclosure, the circulation line may be connected to an upper end or other portions of the first gas-liquid separator.

In particular, an outlet end of the first circulation line 150 may be connected to the first gas-liquid separator 140 so that the outlet end of the first circulation line 150 is positioned at a position (e.g., a lateral side of an uppermost end of the first gas-liquid separator) higher than a level of the liquid reaction fluid separated by the first gas-liquid separator 140.

The first bypass line 160 is configured to allow the liquid reaction fluid, which is separated by the first gas-liquid separator 140, to selectively flow to the upstream side of the first gas-liquid separator 140 (the upstream side of the first filter part) without being supplied to the water electrolysis stack 20.

More specifically, one end of the first bypass line 160 is provided between the first gas-liquid separator 140 and the water electrolysis stack 20 (e.g., the inlet of the anode) and connected to the reaction fluid supply line 130, and the other end of the first bypass line 160 is provided at the upstream side of the first filter part 132 (e.g., between the reaction fluid storage part and the first filter part) and connected to the reaction fluid supply line 130.

The first bypass line 160 may have various structures in accordance with required conditions and design specifications. The present disclosure is not restricted or limited by the structure and shape of the first bypass line 160. For example, the first bypass line 160 may have an approximately straight shape. According to another embodiment of the present disclosure, the first bypass line may have a curved shape or other shapes.

According to the example embodiment of the present disclosure, the electrochemical system 10 may include first ion sensors 171 and 172 provided in the reaction fluid supply line 130, disposed at the upstream side of the first gas-liquid separator 140, and configured to sense ionic conductivity of the reaction fluid. The operation of the water electrolysis stack 20 may be selectively stopped on the basis of the result detected by the first ion sensors 171 and 172.

Various ion sensors capable of sensing the ionic conductivity of the reaction fluid may be used as the first ion sensors 171 and 172. The present disclosure is not restricted or limited by the types and structures of the first ion sensors 171 and 172.

Hereinafter, an example will be described in which the first ion sensors 171 and 172 are respectively provided in the reaction fluid storage part 120 and the reaction fluid supply line 130 (e.g., between the pre-processing filter part and the reaction fluid storage part).

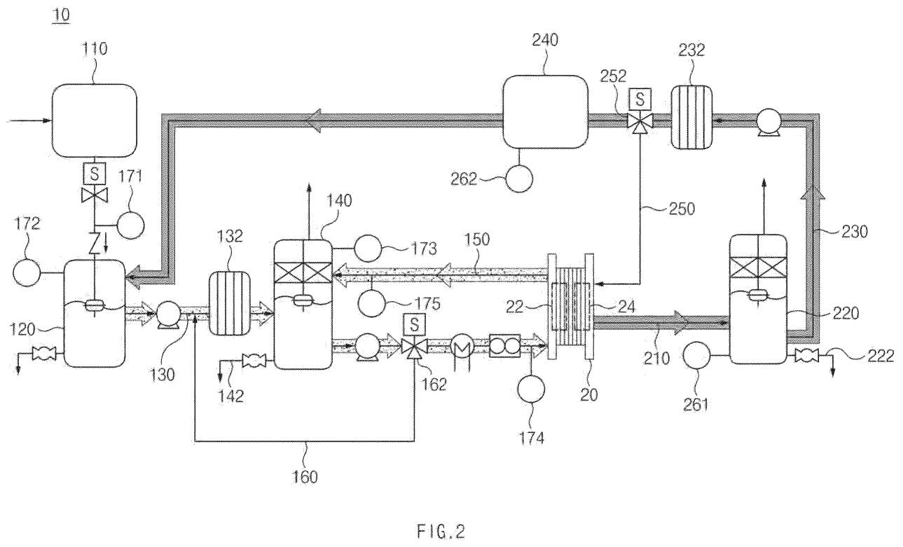

For example, with reference to FIG. 2, in case that the ionic conductivity of the reaction fluid sensed by the first ion sensors 171 and 172 is lower than preset reference ionic conductivity (e.g., 0.1 μS/cm), the reaction fluid stored in the reaction fluid storage part 120 may be supplied to the water electrolysis stack 20 via the first gas-liquid separator 140, and the water electrolysis stack 20 may normally operate.

In contrast, in case that the ionic conductivity of the reaction fluid sensed by the first ion sensors 171 and 172 is higher than the preset reference ionic conductivity (e.g., 0.1 μS/cm), it may be determined that the lifespan of the pre-processing filter has ended, and the operation of the water electrolysis stack 20 may be stopped.

In particular, when the timing for replacing the pre-processing filter part 110 is reached (in case that the ionic conductivity of the reaction fluid sensed by the first ion sensors 171 and 172 is higher than the reference ionic conductivity), an alarm generation part (not illustrated) generates a visual alarm signal (e.g., a notification window on a control program screen) or an auditory alarm signal to allow an operator to recognize an end-of-life situation of the pre-processing filter part 110 and thus allow the operator to replace the pre-processing filter part 110, which is at the end of life, in a timely manner.

As described above, in the embodiment of the present disclosure, the first ion sensors 171 and 172 are provided in the reaction fluid supply line 130, and the operation of the water electrolysis stack 20 is selectively stopped on the basis of the result detected by the first ion sensors 171 and 172. Therefore, it is possible to obtain an advantageous effect of minimizing a degree to which a low-quality reaction fluid is supplied to the water electrolysis stack 20 and improving the durability and stability.

According to the example embodiment of the present disclosure, the electrochemical system 10 may include a first three-way valve 162 provided in the reaction fluid supply line 130 and connected to one end of the first bypass line 160.

Various three-way valves capable of allowing the liquid reaction fluid, which is supplied from the first gas-liquid separator 140 to the water electrolysis stack 20, to selectively flow to the first bypass line 160 may be used as the first three-way valve 162. The present disclosure is not restricted or limited by the type and structure of the first three-way valve 162.

For example, the first three-way valve 162 may include a first port (not illustrated) into which the liquid reaction fluid discharged from the first gas-liquid separator 140 is introduced, a second port (not illustrated) configured to guide the liquid reaction fluid, which has passed through the first port, to the water electrolysis stack 20, and a third port (not illustrated) connected to the first bypass line 160 and configured to guide the reaction fluid, which has passed through the first port, to the first bypass line 160. The first three-way valve 162 may selectively switch the movement path for the liquid reaction fluid by opening or closing the first to third ports.

In this case, the operation of opening or closing the first to third ports is defined as including both an operation of completely closing or opening the first to third ports and an operation of adjusting an opening degree (valve opening angle) (e.g., adjusting a degree to which the port is opened).

According to the example embodiment of the present disclosure, the electrochemical system 10 may include second ion sensors 173, 174, and 175 provided in at least any one of the reaction fluid supply line 130 and the first circulation line 150 and configured to sense the ionic conductivity of the liquid reaction fluid. The first three-way valve 162 may selectively switch the flow of the liquid reaction fluid from the downstream side of the first gas-liquid separator 140 to the upstream side of the first gas-liquid separator 140 on the basis of the result detected by the second ion sensors 173, 174, and 175.

Hereinafter, an example will be described in which the second ion sensors 173, 174, and 175 are respectively provided in the first gas-liquid separator 140, the reaction fluid supply line 130 (e.g., between the first gas-liquid separator and the water electrolysis stack), and the first circulation line 150.

Various ion sensors capable of sensing the ionic conductivity of the liquid reaction fluid may be used as the second ion sensors 173, 174, and 175. The present disclosure is not restricted or limited by the types and structures of the second ion sensors 173, 174, and 175.

In particular, the movement path for the liquid reaction fluid may be controlled by controlling the first three-way valve 162 on the basis of the result detected by the second ion sensors 173, 174, and 175.

That is, the first three-way valve 162 may be configured to allow the liquid reaction fluid to selectively flow from the downstream side of the first gas-liquid separator 140 to the upstream side of the first gas-liquid separator 140 (the upstream side of the first filter part) on the basis of the result detected by the second ion sensors 173, 174, and 175.

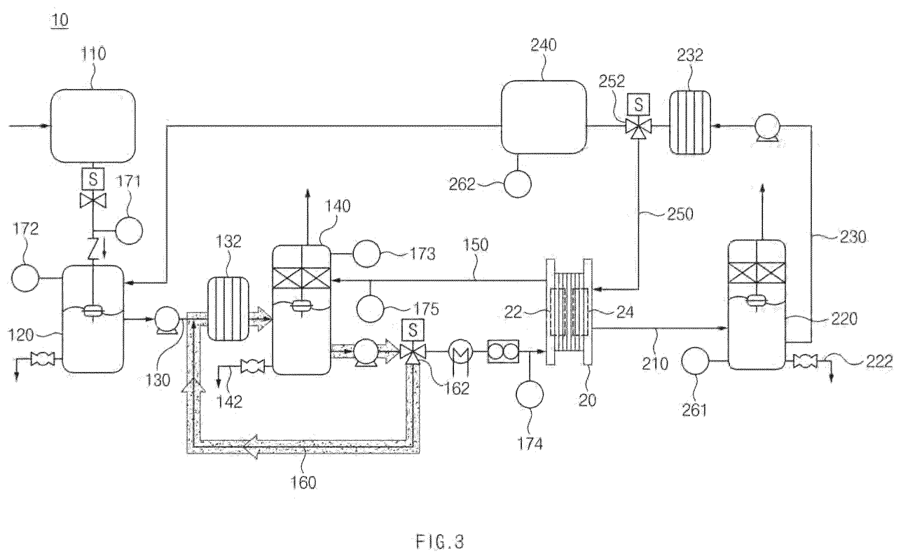

For example, with reference to FIG. 3, in case that the ionic conductivity of the liquid reaction fluid sensed by the second ion sensors 173, 174, and 175 is higher than the preset reference ionic conductivity (e.g., 0.1 μS/cm), the first three-way valve 162 may be controlled such that the liquid reaction fluid separated by the first gas-liquid separator 140 may flow to the upstream side of the first filter part 132 along the first bypass line 160 without being supplied to the water electrolysis stack 20.

In contrast, as illustrated in FIG. 2, in case that the ionic conductivity of the liquid reaction fluid sensed by the second ion sensors 173, 174, and 175 is equal to or lower than the preset reference ionic conductivity (e.g., 0.1 μS/cm), the first three-way valve 162 may be controlled such that the liquid reaction fluid separated by the first gas-liquid separator 140 is supplied to the water electrolysis stack 20 instead of the first bypass line 160, and the liquid reaction fluid may be used as water to be supplied to the water electrolysis stack 20.

As described above, in the embodiment of the present disclosure, the liquid reaction fluid separated by the first gas-liquid separator 140 selectively flows to the upstream side of the first filter part 132 without being supplied to the water electrolysis stack 20. Therefore, it is possible to obtain an advantageous effect of ensuring the quality of the reaction fluid to be supplied to the water electrolysis stack 20, improving the recyclability of the reaction fluid, and improving the durability and stability.

This is based on the fact that the performance, durability, and stability of the water electrolysis stack 20 deteriorate when a low-quality reaction fluid (e.g., a liquid reaction fluid having high ionic conductivity) is supplied to the water electrolysis stack 20. In the embodiment of the present disclosure, in case that the ionic conductivity of the liquid reaction fluid separated by the first gas-liquid separator 140 is higher than the reference ionic conductivity (e.g., 0.1 μS/cm), the liquid reaction fluid flows to the upstream side of the first filter part 132 along the first bypass line 160 without being supplied to the water electrolysis stack 20, and then the liquid reaction fluid is reprocessed (deionized while repeatedly circulating through the first filter part). Therefore, it is possible to obtain an advantageous effect of ensuring the quality of the reaction fluid to be supplied to the water electrolysis stack 20, improving the recyclability of the reaction fluid, and improving the durability and stability.

Among other things, according to the embodiment of the present disclosure, it is possible to obtain an advantageous effect of extending the lifespan of the water electrolysis stack 20 and minimizing the deterioration in durability and stability of the water electrolysis stack 20 caused when the low-quality reaction fluid is supplied to the water electrolysis stack 20.

According to the example embodiment of the present disclosure, the first filter part 132 may be replaced when the ionic conductivity of the liquid reaction fluid detected by the second ion sensors 173, 174, and 175 is equal to or higher than the preset reference ionic conductivity when a preset reference time (e.g., 30 minutes) elapses after the flow of the liquid reaction fluid is switched from the downstream side of the first gas-liquid separator 140 to the upstream side of the first gas-liquid separator 140.

In particular, when the timing for replacing the first filter part 132 is reached (in case that the ionic conductivity of the liquid reaction fluid is higher than the reference ionic conductivity in a state in which a reference time elapses after the flow of the liquid reaction fluid is switched to the upstream side of the first gas-liquid separator 140), the alarm generation part (not illustrated) generates a visual alarm signal (e.g., a notification window on the control program screen) or an auditory alarm signal to allow the operator to recognize an end-of-life situation of the first filter part 132 and thus allow the operator to replace the first filter part 132, which is at the end of life, in a timely manner.

According to the example embodiment of the present disclosure, the electrochemical system 10 may include a discharged fluid discharge line 210 connected to the cathode 24 and configured to discharge a discharged fluid from the cathode 24, a second gas-liquid separator 220 provided in the discharged fluid discharge line 210 and configured to separate the discharged fluid into a gaseous discharged fluid and a liquid discharged fluid, and the second circulation line 230 configured to connect the second gas-liquid separator 220 and the reaction fluid supply line 130 and configured to circulate the liquid discharged fluid to the reaction fluid supply line 130.

The discharged fluid discharge line 210 is configured to discharge the discharged fluid (e.g., hydrogen+water) from the cathode 24.

The discharged fluid discharge line 210 may have various structures capable of discharging the discharged fluid. The present disclosure is not restricted or limited by the structure and shape of the discharged fluid discharge line 210.

For example, the discharged fluid discharge line 210 may be defined in an approximately straight shape. According to another embodiment of the present disclosure, the discharged fluid discharge line may be defined in a curved shape or other shapes.

In addition, the discharged fluid discharge line 210 may be equipped with various types of accessory devices such as a pump (not illustrated) configured to forcibly move the discharged fluid along the discharged fluid discharge line 210, and a valve (not illustrated) configured to selectively open or close the discharged fluid discharge line 210. The present disclosure is not restricted or limited by the types of accessory devices and the number of accessory devices.

The second gas-liquid separator 220 is connected to the discharged fluid discharge line 210 and configured to separate the discharged fluid, which is discharged from the cathode 24, into the gaseous discharged fluid (e.g., hydrogen) and the liquid discharged fluid (water).

Various separation devices capable of separating the discharged fluid into the gaseous discharged fluid and the liquid discharged fluid may be used as the second gas-liquid separator 220. The present disclosure is not restricted or limited by the type and structure of the second gas-liquid separator 220.

For example, the second gas-liquid separator 220 may be provided in the form of a hollow tank. For example, the discharge line 210 may be connected to an approximately central portion of the second gas-liquid separator 220. A second discharge line 222 may be provided at an approximately lower end of the second gas-liquid separator 220 and configured to selectively discharge the liquid discharged fluid in the second gas-liquid separator 220 to the outside. In addition, a level sensor (not illustrated) may be provided in the second gas-liquid separator 220 and configured to detect a level of the liquid discharged fluid.

The second circulation line 230 may be configured to connect the second gas-liquid separator 220 and the reaction fluid supply line 130. The liquid discharged fluid separated by the second gas-liquid separator 220 may circulate to the reaction fluid supply line 130 along the second circulation line 230.

For example, the second circulation line 230 may be connected to the reaction fluid supply line 130 by means of the reaction fluid storage part 120. According to another embodiment of the present disclosure, the second circulation line may be connected directly to the reaction fluid supply line.

The second circulation line 230 may have various structures capable of connecting the second gas-liquid separator 220 and the reaction fluid supply line 130. The present disclosure is not restricted or limited by the structure and shape of the second circulation line 230.

Hereinafter, an example will be described in which the second circulation line 230 is connected to a lateral side (based on FIG. 1) of the second gas-liquid separator 220. According to another embodiment of the present disclosure, the circulation line may be connected to an upper end or other portions of the second gas-liquid separator.

In particular, an inlet end of the second circulation line 230 may be connected to the second gas-liquid separator 220 so that the inlet end of the second circulation line 230 is positioned at a position lower than a level of the liquid discharged fluid separated by the second gas-liquid separator 220.

According to the example embodiment of the present disclosure, the electrochemical system 10 may include a second filter part 232 provided in the second circulation line 230 and configured to filter the liquid discharged fluid.

The second filter part 232 is configured to filter the liquid discharged fluid to be supplied to the reaction fluid supply line 130 along the second circulation line 230.

Various ion filters capable of filtering out ions and foreign substances (impurities) contained in the liquid discharged fluid may be used as the second filter part 232. The present disclosure is not restricted or limited by the type and properties of the ion filter. For example, a prefilter, a carbon filter, a RO membrane filter, an ion exchange resin, a UV Lamp, or the like may be used as the second filter part 232.

For reference, in the embodiment of the present disclosure, an example is described in which the second filter part 232 includes a single ion filter. However, according to another embodiment of the present disclosure, the second filter part may be configured by connecting a plurality of ion filters in parallel or in series.

According to the example embodiment of the present disclosure, the electrochemical system 10 may include a discharged fluid storage part 240 provided in the second circulation line 230, positioned at a downstream side of the second filter part 232 (e.g., between the second filter part and the reaction fluid storage part), and configured to store the liquid discharged fluid.

The discharged fluid storage part 240 may have various structures capable of storing the discharged fluid. The present disclosure is not restricted or limited by the structure and shape of the discharged fluid storage part 240.

For example, the discharged fluid storage part 240 may be provided in the form of a hollow tank. The liquid discharged fluid, which has passed through the second gas-liquid separator 220, may be temporarily stored in the discharged fluid storage part 240 before being supplied to the discharged fluid supply line.

According to the example embodiment of the present disclosure, the electrochemical system 10 may include a second bypass line 250 having one end provided at a downstream side of the second filter part 232 and connected to the second circulation line 230, and the other end connected to the cathode 24.

The second bypass line 250 is configured to allow the liquid discharged fluid separated by the second gas-liquid separator 220 to selectively flow to the cathode 24 without being supplied to the reaction fluid supply line 130.

More specifically, one end of the second bypass line 250 is provided between the second filter part 232 and the discharged fluid storage part 240 and connected to the second circulation line 230, and the other end of the second bypass line 250 is connected to the cathode 24 of the water electrolysis stack 20.

The second bypass line 250 may have various structures in accordance with required conditions and design specifications. The present disclosure is not restricted or limited by the structure and shape of the second bypass line 250. For example, the second bypass line 250 may have an approximately straight shape. According to another embodiment of the present disclosure, the second bypass line may have a curved shape or other shapes.

According to the example embodiment of the present disclosure, the electrochemical system 10 may include a second three-way valve 252 provided in the second circulation line 230 and connected to one end of the second bypass line 250.

Various three-way valves capable of allowing the liquid discharged fluid, which is supplied from the second gas-liquid separator 220 to the reaction fluid supply line 130, to selectively flow to the cathode 24 may be used as the second three-way valve 252. The present disclosure is not restricted or limited by the type and structure of the second three-way valve 252.

For example, the second three-way valve 252 may have a structure identical or similar to the above-mentioned structure of the first three-way valve 162.

According to the example embodiment of the present disclosure, the electrochemical system 10 may include third ion sensors 261 and 262 provided in at least any one of the discharged fluid discharge line 210 and the second circulation line 230 and configured to sense the ionic conductivity of the liquid discharged fluid. The second three-way valve 252 may selectively switch the flow of the liquid discharged fluid from the downstream side of the second filter part 232 to the cathode 24 on the basis of the result detected by the third ion sensors 261 and 262.

Hereinafter, an example will be described in which the third ion sensors 261 and 262 are respectively provided in the second gas-liquid separator 220 and the discharged fluid storage part 240.

Various ion sensors capable of sensing the ionic conductivity of the liquid discharged fluid may be used as the third ion sensors 261 and 262. The present disclosure is not restricted or limited by the types and structures of the third ion sensors 261 and 262.

In particular, the movement path for the liquid discharged fluid may be controlled by controlling the second three-way valve 252 on the basis of the result detected by the third ion sensors 261 and 262.

That is, the second three-way valve 252 may be configured to selectively switch the flow of the liquid discharged fluid from the downstream side of the second filter part 232 to the cathode 24 on the basis of the result detected by the third ion sensors 261 and 262.

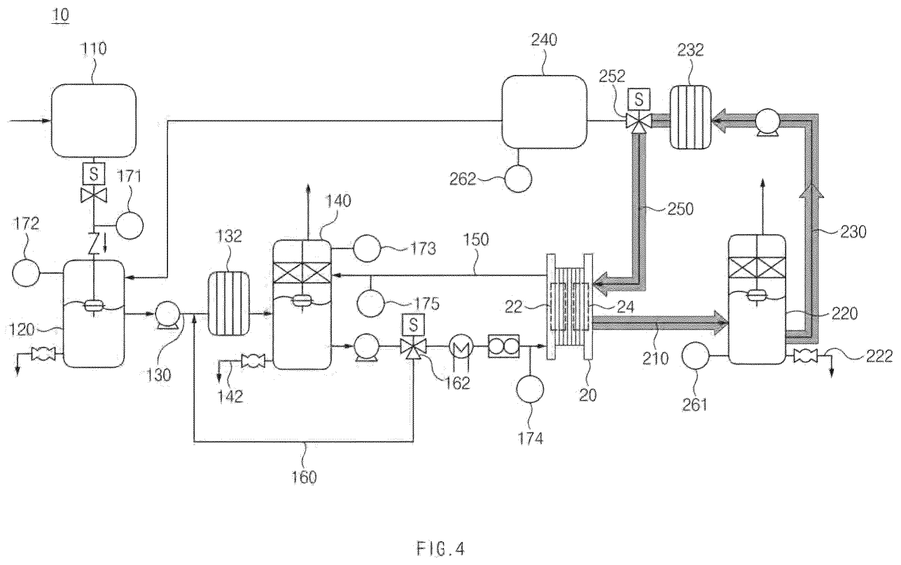

For example, with reference to FIG. 4, in case that the ionic conductivity of the liquid discharged fluid sensed by the third ion sensors 261 and 262 is higher than the preset reference ionic conductivity (e.g., 0.1 μS/cm), the second three-way valve 252 may be controlled such that the liquid discharged fluid separated by the second gas-liquid separator 220 may flow to the cathode 24 along the second bypass line 250 without being supplied to the reaction fluid supply line 130.

In contrast, as illustrated in FIG. 2, in case that the ionic conductivity of the liquid discharged fluid sensed by the third ion sensors 261 and 262 is equal to or lower than the preset reference ionic conductivity (e.g., 0.1 μS/cm), the second three-way valve 252 may be controlled such that the liquid discharged fluid separated by the second gas-liquid separator 220 is supplied to the reaction fluid supply line 130 instead of the second bypass line 250, and then the liquid discharged fluid may be used as water to be supplied to the water electrolysis stack 20.

As described above, in the embodiment of the present disclosure, the second gas-liquid separator 220 separates the discharged fluid, which is discharged from the cathode 24, into the liquid discharged fluid, and the liquid discharged fluid is supplied to the reaction fluid supply line 130 and used again as water to be supplied to the water electrolysis stack 20. Therefore, it is possible to obtain an advantageous effect of improving the recyclability of the reaction fluid and reducing the amount of use of the reaction fluid.

In addition, in the embodiment of the present disclosure, when the quality of the liquid discharged fluid is degraded (the ionic conductivity is increased), the liquid discharged fluid flows to the cathode 24 without being supplied to the reaction fluid supply line 130. Therefore, it is possible to obtain an advantageous effect of ensuring the quality of the reaction fluid to be supplied to the water electrolysis stack 20 and improving the durability and stability.

That is, in case that the ionic conductivity of the liquid discharged fluid separated by the second gas-liquid separator 220 is higher than the reference ionic conductivity (e.g., 0.1 μS/cm), the liquid discharged fluid flows to the cathode 24 along the second bypass line 250 without being supplied to the reaction fluid supply line 130, and then the liquid discharged fluid is reprocessed (deionized while repeatedly circulating through the second filter part). Therefore, it is possible to obtain an advantageous effect of ensuring the quality of the reaction fluid to be supplied to the water electrolysis stack 20, improving the recyclability of the reaction fluid, and improving the durability and stability.

Moreover, in the embodiment of the present disclosure, the liquid discharged fluid passes through the cathode 24 while the liquid discharged fluid is reprocessed while repeatedly circulating through the second filter part 232. Therefore, it is possible to flush (clean) the cathode 24 by using the liquid discharged fluid without a separate flushing device.

According to the example embodiment of the present disclosure, the second filter part 232 may be replaced when the ionic conductivity of the liquid discharged fluid detected by the third ion sensors 261 and 262 is equal to or higher than the preset reference ionic conductivity when a preset reference time (e.g., 30 minutes) elapses after the flow of the liquid discharged fluid is switched from the downstream side of the second filter part 232 to the cathode 24.

In particular, when the timing for replacing the second filter part 232 is reached (in case that the ionic conductivity of the liquid discharged fluid is higher than the reference ionic conductivity in a state in which a reference time elapses after the flow of the liquid discharged fluid is switched to the anode 22), the alarm generation part (not illustrated) generates a visual alarm signal (e.g., a notification window on the control program screen) or an auditory alarm signal to allow the operator to recognize an end-of-life situation of the second filter part 232 and thus allow the operator to replace the second filter part 232, which is at the end of life, in a timely manner.

According to the embodiment of the present disclosure described above, it is possible to obtain an advantageous effect of ensuring the performance of the water electrolysis stack and improving the durability and stability of the water electrolysis stack.

In particular, according to the embodiment of the present disclosure, the low-quality reaction fluid (e.g., the reaction fluid having high ionic conductivity) flows to the circulation line along the bypass line without being supplied to the water electrolysis stack, and then the low-quality reaction fluid is reprocessed (e.g., deionized). Therefore, it is possible to obtain an advantageous effect of ensuring the quality of the reaction fluid to be supplied to the water electrolysis stack, improving the recyclability of the reaction fluid, and improving the durability and stability.

Among other things, according to the embodiment of the present disclosure, it is possible to obtain an advantageous effect of extending the lifespan of the water electrolysis stack and minimizing the deterioration in durability and stability of the water electrolysis stack caused when the low-quality reaction fluid is supplied to the water electrolysis stack.

In addition, according to the embodiment of the present disclosure, it is possible to obtain an advantageous effect of improving the quality and recyclability of the reaction fluid and reducing the amount of use of the reaction fluid.

In particular, according to the embodiment of the present disclosure, the discharged fluid discharged from the cathode may be reused as the reaction fluid, which may improve the recyclability of the reaction fluid and reduce the amount of use of the reaction fluid.

In addition, according to the embodiment of the present disclosure, it is possible to flush (clean) the cathode by using the discharged fluid without a separate flushing device.

While the embodiments have been described above, the embodiments are just illustrative and not intended to limit the present disclosure. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the present disclosure defined by the appended claims.

What is claimed is:

1. An electrochemical system comprising:
a water electrolysis stack comprising an anode and a cathode;
a reaction fluid supply line configured to supply a reaction fluid to the anode;
a first gas-liquid separator located in the reaction fluid supply line and configured to separate the reaction fluid into a gaseous reaction fluid and a liquid reaction fluid;
a first filter part located in the reaction fluid supply line, located at an upstream side of the first gas-liquid separator, and configured to filter the reaction fluid;
a first circulation line configured to connect the first gas-liquid separator and the anode and circulate the liquid reaction fluid, which has passed through the anode, to the first gas-liquid separator; and
a first bypass line having one end located between the first gas-liquid separator and the water electrolysis stack and connected to the reaction fluid supply line, and the other end located at an upstream side of the first filter part and connected to the reaction fluid supply line.

2. The electrochemical system of claim 1, comprising:
a first ion sensor located in the reaction fluid supply line, disposed at the upstream side of the first gas-liquid separator, and configured to sense ionic conductivity of the reaction fluid,
wherein an operation of the water electrolysis stack is configured to be selectively controlled based on a detection by the first ion sensor.

3. The electrochemical system of claim 1, comprising:
a first three-way valve located in the reaction fluid supply line and connected to one end of the first bypass line.

4. The electrochemical system of claim 3, comprising:
a second ion sensor located in at least any one of the reaction fluid supply line and the first circulation line and configured to sense ionic conductivity of the liquid reaction fluid,
wherein the first three-way valve is configured to selectively switch a flow of the liquid reaction fluid from a downstream side of the first gas-liquid separator to the upstream side of the first gas-liquid separator based on a detection by the second ion sensor.

5. The electrochemical system of claim 4, wherein the first filter part is replaced when the ionic conductivity of the liquid reaction fluid detected by the second ion sensor is equal to or higher than preset reference ionic conductivity when a preset reference time elapses after the flow of the liquid reaction fluid is switched from the downstream side of the first gas-liquid separator to the upstream side of the first gas-liquid separator.

6. The electrochemical system of claim 1, comprising:
a discharged fluid discharge line connected to the cathode and configured to discharge a discharged fluid from the cathode;
a second gas-liquid separator located in the discharged fluid discharge line and configured to separate the discharged fluid into a gaseous discharged fluid and a liquid discharged fluid; and
a second circulation line configured to connect the second gas-liquid separator and the reaction fluid supply line and circulate the liquid discharged fluid to the reaction fluid supply line.

7. The electrochemical system of claim 6, comprising:
a reaction fluid storage part located in the reaction fluid supply line, disposed at the upstream side of the first filter part, and configured to store the reaction fluid; and
a pre-processing filter part located in the reaction fluid supply line, disposed at an upstream side of the reaction fluid storage part, and configured to filter the reaction fluid,
wherein the second circulation line is connected to the reaction fluid storage part.

8. The electrochemical system of claim 6, comprising:
a second filter part located in the second circulation line and configured to filter the liquid discharged fluid.

9. The electrochemical system of claim 8, comprising:
a second bypass line having one end located at a downstream side of the second filter part and connected to the second circulation line, and the other end connected to the cathode.

10. The electrochemical system of claim 9, comprising:
a second three-way valve located in the second circulation line and connected to one end of the second bypass line.

11. The electrochemical system of claim 10, comprising:
a third ion sensor located in at least any one of the discharged fluid discharge line and the second circulation line and configured to sense ionic conductivity of the liquid discharged fluid,
wherein the second three-way valve selectively switches a flow of the liquid discharged fluid from the downstream side of the second filter part to the cathode based on a detection by the third ion sensor.

12. The electrochemical system of claim 11, wherein the second filter part is replaced when the ionic conductivity of the liquid discharged fluid detected by the third ion sensor is equal to or higher than preset reference ionic conductivity when a preset reference time elapses after the flow of the liquid discharged fluid is switched from the downstream side of the second filter part to the cathode.

13. The electrochemical system of claim 8, comprising:
a discharged fluid storage part located in the second circulation line, disposed at a downstream side of the second filter part, and configured to store the liquid discharged fluid.

14. An electrochemical system comprising:
a water electrolysis stack comprising an anode and a cathode;
a reaction fluid supply line configured to supply a reaction fluid to the anode;
a first gas-liquid separator located in the reaction fluid supply line and configured to separate the reaction fluid into a gaseous reaction fluid and a liquid reaction fluid;
a first filter part located in the reaction fluid supply line, positioned at an upstream side of the first gas-liquid separator, and configured to filter the reaction fluid;
a first circulation line configured to connect the first gas-liquid separator and the anode and circulate the liquid reaction fluid, which has passed through the anode, to the first gas-liquid separator;
a reaction fluid storage part located in the reaction fluid supply line, disposed at an upstream side of the first filter part, and configured to store the reaction fluid;
a first ion sensor located in the reaction fluid supply line upstream of the first gas-liquid separator and configured to detect the ionic conductivity of the reaction fluid;
a second ion sensor located in at least one of the reaction fluid supply line and the first circulation line, and configured to detect the ionic conductivity of the liquid reaction fluid;
wherein the electrochemical system further comprises a system configured to selectively stop the operation of the water electrolysis stack based on the ionic conductivity detected by the first and second ion sensors.

15. The electrochemical system of claim 14, further comprising:
a sensor configured to monitor the ionic conductivity of the reaction fluid, wherein the system is configured to replace the first filter part when the ionic conductivity exceeds a predetermined threshold.

16. The electrochemical system of claim 14, wherein the control system is configured to selectively stop the operation of the water electrolysis stack when a specific ionic conductivity threshold is detected.

17. The electrochemical system of claim 14, wherein the reaction fluid storage part is configured to store the reaction fluid before it is supplied to the first filter part.

18. An electrochemical system comprising:
a water electrolysis stack comprising an anode and a cathode;
a reaction fluid supply line configured to supply a reaction fluid to the anode;
a first gas-liquid separator located in the reaction fluid supply line and configured to separate the reaction fluid into a gaseous reaction fluid and a liquid reaction fluid;
a first filter part located in the reaction fluid supply line, located at an upstream side of the first gas-liquid separator, and configured to filter the reaction fluid;
a first circulation line configured to connect the first gas-liquid separator and the anode and circulate the liquid reaction fluid, which has passed through the anode, to the first gas-liquid separator;
a second circulation line configured to connect a second gas-liquid separator and the reaction fluid supply line, wherein the second gas-liquid separator is located in a discharged fluid discharge line connected to the cathode;
wherein the electrochemical system further comprises a filtration mechanism in the second circulation line to maintain the ionic purity of the liquid discharged fluid.

19. The electrochemical system of claim 18, wherein the system is further configured to trigger an alert or notification when the ionic conductivity detected by the first or the second ion sensor exceeds a predetermined threshold.

20. The electrochemical system of claim 18, further comprising:
a reaction fluid storage part located in the reaction fluid supply line, disposed at an upstream side of the first filter part, and configured to store the reaction fluid.
